(19) United States
(12) Patent Application Publication
(10) Pub. No.: US 2013/0194999 A1
(43) Pub. Date: Aug. 1, 2013

(54) CLIENT-ASSISTED TARGET MULTICAST AREA DETECTION

(71) Applicant: QUALCOMM Incorporated, San Diego, CA (US)

(72) Inventor: Kirankumar Anchan, San Diego, CA (US)

(73) Assignee: QUALCOMM INCORPORATED, San Diego, CA (US)

(21) Appl. No.: 13/722,164

(22) Filed: Dec. 20, 2012

Related U.S. Application Data
(60) Provisional application No. 61/581,024, filed on Dec. 28, 2011.

(51) Int. Cl. H04W 4/06

(52) U.S. Cl. CPC H04W 4/06
USPC 370/312

(57) ABSTRACT

The disclosure is directed to group communications over multimedia broadcast/multicast services (MBMS). An aspect receives location information for each of a plurality of multicast-enabled target user devices, determines one or more area polygons based on the location information, each area polygon comprising a list of network components configured to provide multicast services to a subset of the plurality of multicast-enabled target user devices, and stores the one or more area polygons. An aspect receives a call request to establish a group call among a plurality of multicast-enabled target user devices, identifies one or more area polygons corresponding to the plurality of multicast-enabled target user devices, and provides a list of network components obtained from the one or more area polygons to one or more broadcast multicast service centers (BM-SCs) serving the plurality of multicast-enabled target user devices.

### CLAIM OF PRIORITY UNDER 35 U.S.C. §119

The present Application for Patent claims priority to Provisional Application No. 61/581,024, entitled “CLIENT-ASSISTED TARGET MULTICAST AREA DETECTION,” filed Dec. 28, 2011, and assigned to the assignee hereof and hereby expressly incorporated by reference herein.

### FIELD OF THE DISCLOSURE

The present disclosure relates generally to communication, and more specifically to techniques for supporting group communications on broadcast and multicast services in a cellular communication system.

### BACKGROUND

A cellular communication system can support bi-directional communication for multiple users by sharing the available system resources. Cellular systems are different from broadcast systems that can mainly or only support unidirectional transmission from broadcast stations to users. Cellular systems are widely deployed to provide various communication services and may be multiple-access systems such as Code Division Multiple Access (CDMA) systems, Time Division Multiple Access (TDMA) systems, Frequency Division Multiple Access (FDMA) systems, Orthogonal FDMA (OFDMA) systems, Single-Carrier FDMA (SC-FDMA) systems, etc.

A cellular system may support broadcast, multicast, and unicast services. A broadcast service is a service that may be received by all users, e.g., news broadcast. A multicast service is a service that may be received by a group of users, e.g., a subscription video service. A unicast service is a service intended for a specific user, e.g., voice call. Group communications can be implemented using either unicast, broadcast, multicast or a combination of each. As the group becomes larger it is generally more efficient to use multicast services. However, for group communication services that require low latency and a short time to establish the group communication, the setup time of conventional multicast channels can be a detriment to system performance

According to the current evolved multimedia broadcast multicast service (eMBMS) standards, the bearers for multicast calls are set up statically or semi-statically. That is, the bearers need to be established before the call is started. This means that the target geographical area has to be identified and the network components have to be connected with the resources allocated for the bearers. Additionally, the group member list needs to be pre-provisioned, resulting in a static group experience. Further, the eMBMS bearers must be maintained, which wastes over-the-air (OTA) and network resources.

### SUMMARY

The disclosure is directed to group communications over multimedia broadcast/multicast services (MBMS). An aspect receives location information for each of a plurality of multicast-enabled target user devices, determines one or more area polygons based on the location information, each area polygon comprising a list of network components configured to provide multicast services to a subset of the plurality of multicast-enabled target user devices, and stores the one or more area polygons. An aspect receives a call request to establish a group call among a plurality of multicast-enabled target user devices, identifies one or more area polygons corresponding to the plurality of multicast-enabled target user devices, and provides a list of network components obtained from the one or more area polygons to one or more broadcast multicast service centers (BM-SCs) serving the plurality of multicast-enabled target user devices.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a wireless communication system.

FIG. 2 illustrates an example transmission structure.

FIG. 3 illustrates example transmissions of different services in a multi-cell mode.

FIG. 4 illustrates example transmissions of different services in a single-cell mode.

FIGS. 5A and 5B illustrate additional wireless communication systems that can support broadcast/multicast services.

FIG. 6 illustrates a block diagram of a portion of a wireless communication system that can support broadcast/multicast services.

FIG. 7 illustrates a communication device that includes logic configured to receive and/or transmit information.

FIG. 8 is an exemplary flow of an embodiment.

FIG. 9 illustrates an exemplary system according to an embodiment.

FIG. 10 is an exemplary flow of an embodiment.

FIG. 11 illustrates an exemplary system according to an embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation. Further, as used herein the term group communication, push-to-talk, or similar variations are meant to refer to a server arbitrated service between two or more devices.

The terminology used herein is for the purpose of describing particular embodiments only and is not intended to be limiting of embodiments of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The techniques described herein may be used for various cellular communication systems such as Code Division Multiple Access (CDMA), Time Division Multiple Access (TDMA), Frequency division multiple access (FDMA), Orthogonal Frequency Division Multiple Access (OFDMA), and Single Carrier FDMA (SC-FDMA) systems. The terms “system” and “network” are often used interchangeably. A CDMA system may implement a radio technology such as Universal Terrestrial Radio Access (UTRA), cdma2000, etc. UTRA includes Wideband CDMA (W-CDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for LTE, and LTE terminology is used in much of the description below.

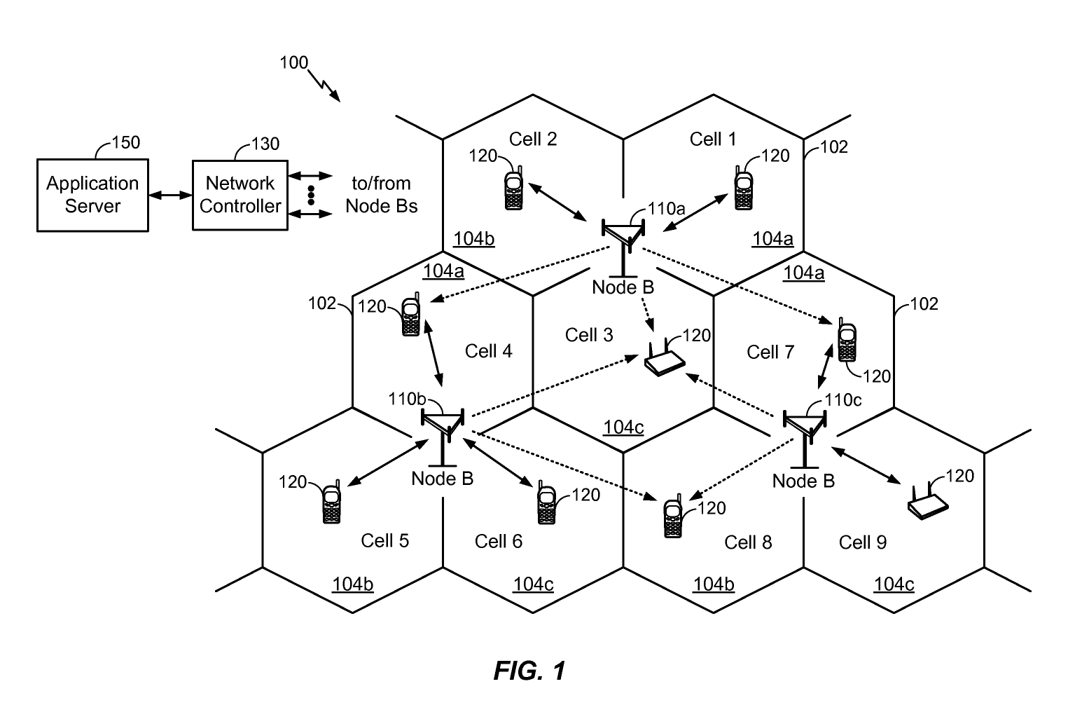

FIG. 1 shows a cellular communication system 100, which may be an LTE system. System 100 may include a number of Node Bs and other network entities. For simplicity, only three Node Bs 110a, 110b and 110c are shown in FIG. 1. A Node B may be a fixed station used for communicating with the user equipments (UEs) and may also be referred to as an evolved Node B (eNB), a base station, an access point, etc. Each Node B 110 provides communication coverage for a particular geographic area 102. To improve system capacity, the overall coverage area of a Node B may be partitioned into multiple smaller areas, e.g., three smaller areas 104a, 104b and 104c. Each smaller area may be served by a respective Node B subsystem. In 3GPP, the term “cell” can refer to the smallest coverage area of a Node B and/or a Node B subsystem serving this coverage area. In other systems, the term “sector” can refer to the smallest coverage area of a base station and/or a base station subsystem serving this coverage area. For clarity, 3GPP concept of a cell is used in the description below.

In the example shown in FIG. 1, each Node B 110 has three cells that cover different geographic areas. For simplicity, FIG. 1 shows the cells not overlapping one another. In a practical deployment, adjacent cells typically overlap one another at the edges, which may allow a UE to receive coverage from one or more cells at any location as the UE moves about the system.

UEs 120 may be dispersed throughout the system, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, etc. A UE may communicate with a Node B via transmissions on the downlink and uplink. The downlink (or forward link) refers to the communication link from the Node B to the UE, and the uplink (or reverse link) refers to the communication link from the UE to the Node B. In FIG. 1, a solid line with double arrows indicates bi-directional communication between a Node B and a UE. A dashed line with a single arrow indicates a UE receiving a downlink signal from a Node B, e.g., for broadcast and/or multicast services. The terms “UE” and “user” are used interchangeably herein.

Network controller 130 may couple to multiple Node Bs to provide coordination and control for the Node Bs under its control, and to route data for terminals served by these Node Bs. Access network 100 may also include other network entities not shown in FIG. 1. Further, as illustrated network controller may be operably coupled to an application server 150 to provide group communication services to the various UEs 120 through access network 100. It will be appreciated that there can be many other network and system entities that can be used to facilitate communications between the UEs and servers and information outside of the access network. Accordingly, the various embodiments disclosed herein are not limited to the specific arrangement or elements detailed in the various figures.

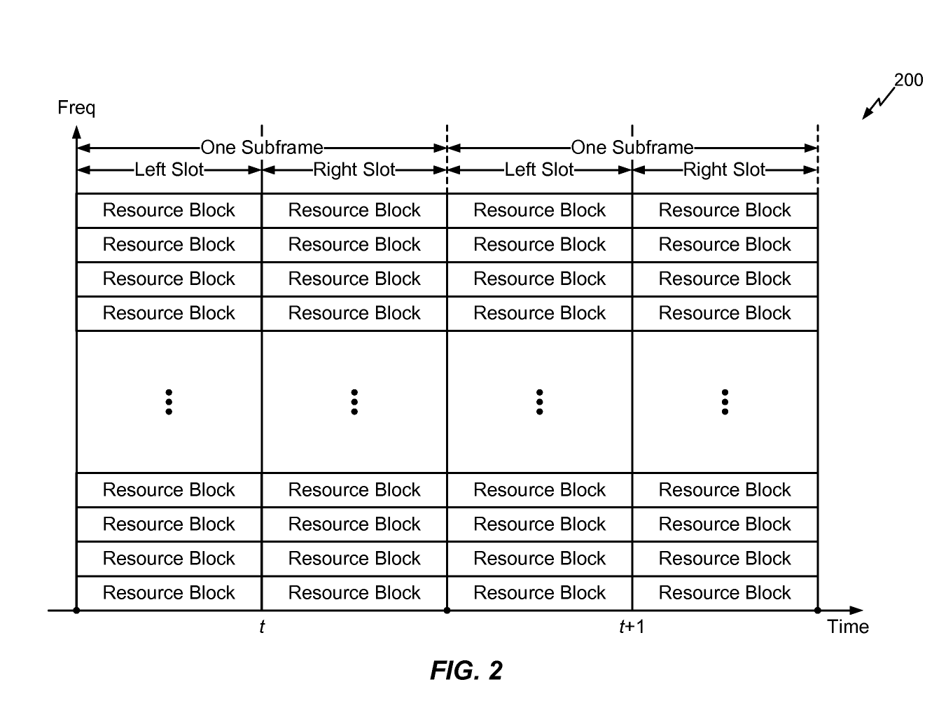

FIG. 2 shows an example transmission structure 200 that may be used for the downlink in system 100. The transmission timeline may be partitioned into units of radio frames. Each radio frame may have a predetermined duration (e.g., 10 milliseconds (ms)) and may be partitioned into 10 sub frames. Each sub frame may include two slots, and each slot may include a fixed or configurable number of symbol periods, e.g., six or seven symbol periods.

The system bandwidth may be partitioned into multiple (K) subcarriers with OFDM. The available time frequency resources may be divided into resource blocks. Each resource block may include Q subcarriers in one slot, where Q may be equal to 12 or some other value. The available resource blocks may be used to send data, overhead information, pilot, etc.

The system may support evolved multimedia broadcast/multicast services (eMBMS) for multiple UEs as well as unicast services for individual UEs. A service for eMBMS may be referred to as an eMBMS service or flow and may be a broadcast service/flow or a multicast service/flow.

In LTE, data and overhead information are processed as logical channels at a Radio Link Control (RLC) layer. The logical channels are mapped to transport channels at a Medium Access Control (MAC) layer. The transport channels are mapped to physical channels at a physical layer (PHY). Table 1 lists some logical channels (denoted as “L”), transport channels (denoted as “T”), and physical channels (denoted as “P”) used in LTE and provides a short description for each channel.

TABLE 1

| Name | Channel | Type | Description |
|---|---|---|---|
| Broadcast Control Channel | BCCH | L | Carry system information |
| Broadcast Channel | BCH | T | Carry master system |
| | | | Information |
| eMBMS Traffic Channel | MTCH | L | Carry configuration |
| | | | information for eMBMS |
| | | | services. |
| Multicast Channel | MCH | T | Carry the MTCH and |
| | | | MCCH |
| Downlink Shared Channel | DL-SCH | T | Carry the MTCH and |
| | | | other logical channels |
| Physical Broadcast Channel | PBCH | P | Carry basic system |
| | | | information for use in |
| | | | acquiring the system. |
| Physical Multicast Channel | PMCH | P | Carry the MCH. |
| Physical Downlink Shared | PDSCH | P | Carry data for the |
| Channel | | | DL-SCH |
| Physical Downlink Control | PDCCH | P | Carry control information |
| Channel | | | for the DL-SCH |

As shown in Table 1, different types of overhead information may be sent on different channels. Table 2 lists some types of overhead information and provides a short description for each type. Table 2 also gives the channel(s) on which each type of overhead information may be sent, in accordance with one design.

TABLE 2

| Overhead | | |
|---|---|---|
| Information | Channel | Description |
| System | BCCH | Information pertinent for communicating |
| Information | | with and/or receiving data from the system. |
| Configuration | MCCH | Information used to receive the Information |
| Information | | services, e.g., MBSFN Area Configuration, |
| | | which contains PMCH configurations, |
| | | Service ID, Session ID, etc. |
| Control | PDCCH | Information used to receive Information |
| Information | | transmissions of data for the services, e.g., |
| | | resource assignments, modulation and |
| | | coding schemes, etc. |

The different types of overhead information may also be referred to by other names. The scheduling and control information may be dynamic whereas the system and configuration information may be semi-static.

The system may support multiple operational modes for eMBMS, which may include a multi-cell mode and a single-cell mode. The multi-cell mode may have the following characteristics:
Content for broadcast or multicast services can be transmitted synchronously across multiple cells.
Radio resources for broadcast and multicast services are allocated by an MBMS Coordinating Entity (MCE), which may be logically located above the Node Bs.
Content for broadcast and multicast services is mapped on the MCH at a Node B.
Time division multiplexing (e.g., at sub frame level) of data for broadcast, multicast, and unicast services.

The single-cell mode may have the following characteristics:
Each cell transmits content for broadcast and multicast services without synchronization with other cells.
Radio resources for broadcast and multicast services are allocated by the Node B.
Content for broadcast and multicast services is mapped on the DL-SCH.
Data for broadcast, multicast, and unicast services may be multiplexed in any manner allowed by the structure of the DL-SCH.

In general, eMBMS services may be supported with the multi-cell mode, the single-cell mode, and/or other modes. The multi-cell mode may be used for eMBMS multicast/broadcast single frequency network (MBSFN) transmission, which may allow a UE to combine signals received from multiple cells in order to improve reception performance

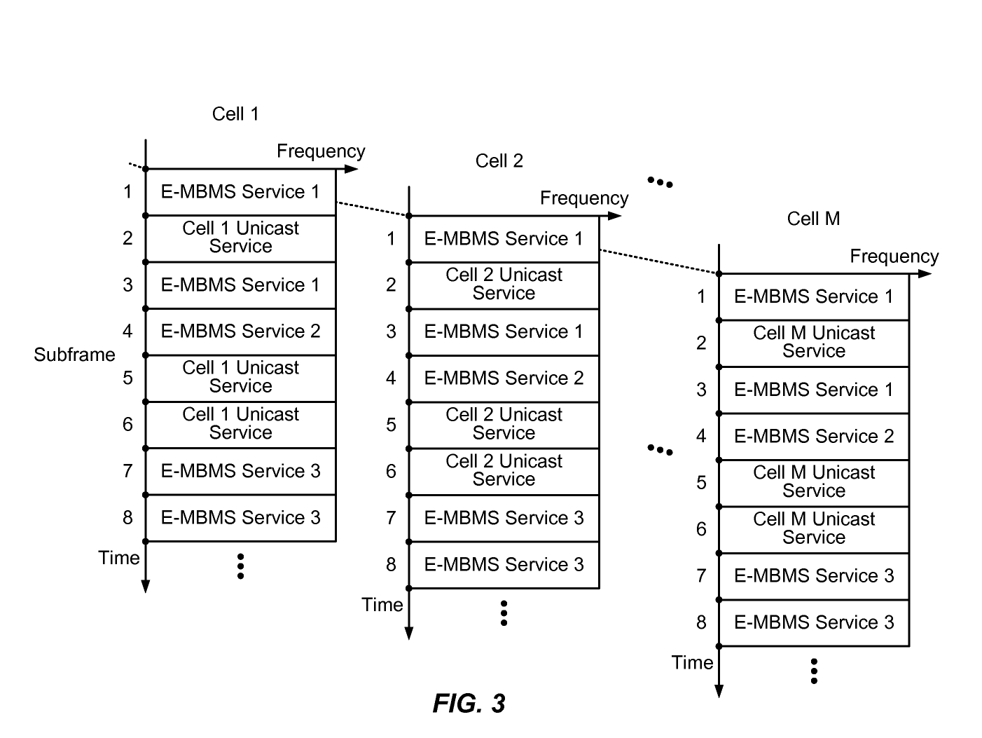

FIG. 3 shows example transmissions of eMBMS and unicast services by M cells 1 through M in the multi-cell mode, where M may be any integer value. For each cell, the horizontal axis may represent time, and the vertical axis may represent frequency. In one design of eMBMS, which is assumed for much of the description below, the transmission time line for each cell may be partitioned into time units of sub frames. In other designs of eMBMS, the transmission time line for each cell may be partitioned into time units of other durations. In general, a time unit may correspond to a sub frame, a slot, a symbol period, multiple symbol periods, multiple slots, multiple sub frames, etc.

In the example shown in FIG. 3, the M cells transmit three eMBMS services 1, 2 and 3. All M cells transmit eMBMS service 1 in sub frames 1 and 3, eMBMS service 2 in sub frame 4, and eMBMS service 3 in sub frames 7 and 8. The M cells transmit the same content for each of the three eMBMS services. Each cell may transmit its own unicast service in sub frames 2, 5 and 6. The M cells may transmit different contents for their unicast services.

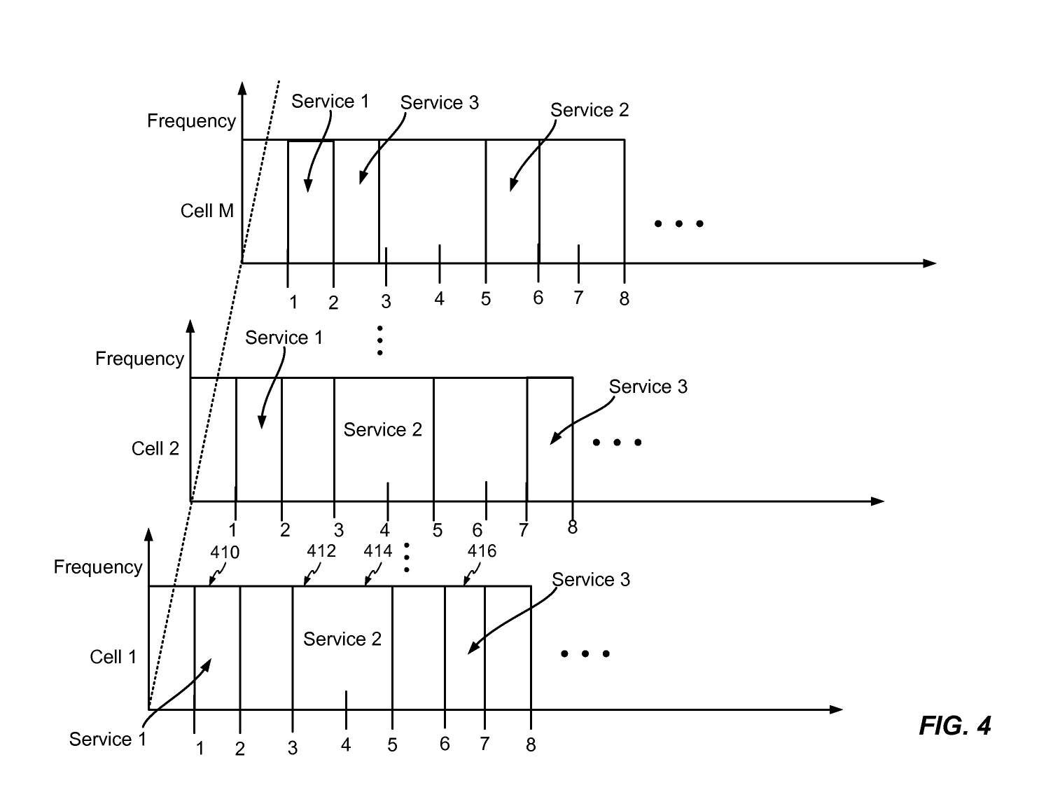

FIG. 4 shows example transmissions of eMBMS and unicast services by M cells in the single-cell mode. For each cell, the horizontal axis may represent time, and the vertical axis may represent frequency. In the example shown in FIG. 4, the M cells transmit three eMBMS services 1, 2 and 3. Cell 1 transmits eMBMS service 1 in one time frequency block 410, eMBMS service 2 in a time frequency blocks 412 and 414, and eMBMS service 3 in one time frequency blocks 416. Similarly other cells transmit services 1, 2 and 3 as shown in FIG. 4.

In general, an eMBMS service may be sent in any number of time frequency blocks. The number of sub frames may be dependent on the amount of data to send and possibly other factors. The M cells may transmit the three eMBMS services 1, 2 and 3 in time frequency blocks that may not be aligned in time and frequency, as shown in FIG. 4. Furthermore, the M cells may transmit the same or different contents for the three eMBMS services. Each cell may transmit its own unicast service in remaining time frequency resources not used for the three eMBMS services. The M cells may transmit different contents for their unicast services.

FIGS. 3 and 4 show example designs of transmitting eMBMS services in the multi-cell mode and the single-cell mode. eMBMS services may also be transmitted in other manners in the multi-cell and single-cell modes, e.g., using time division multiplexing (TDM).

As noted in the foregoing, eMBMS services can be used to distribute multicast data to groups and could be useful in group communication systems (e.g., Push-to-Talk (PTT) calls). Conventional applications on eMBMS have a separate service announcement/discovery mechanism. Further, communications on pre-established eMBMS flows are always-on, even on the air interface. Power saving optimization must be applied to put the UE to sleep when a call/communication is not in progress. This is typically achieved by using out of band service announcements on unicast or multicast user plane data. Alternatively application layer paging channel like mechanism may be used. Since the application layer paging mechanism has to remain active, it consumes bandwidth on the multicast sub-frame which could be idle in the absence of the paging mechanism. Additionally, since the multicast sub-frame will be active while using the application layer paging, the remainder of the resource blocks within the sub frame cannot be used for unicast traffic. Thus the total 5 Mhz bandwidth will be consumed for the sub frame for instances when application layer paging is scheduled without any other data.

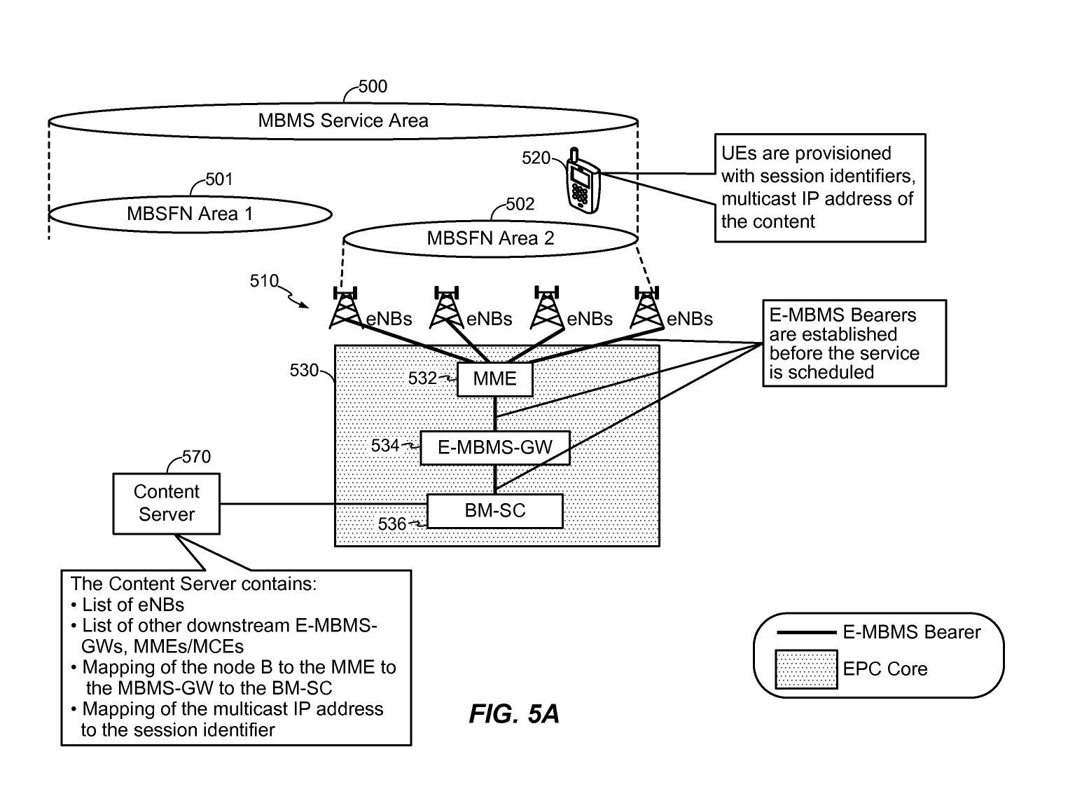

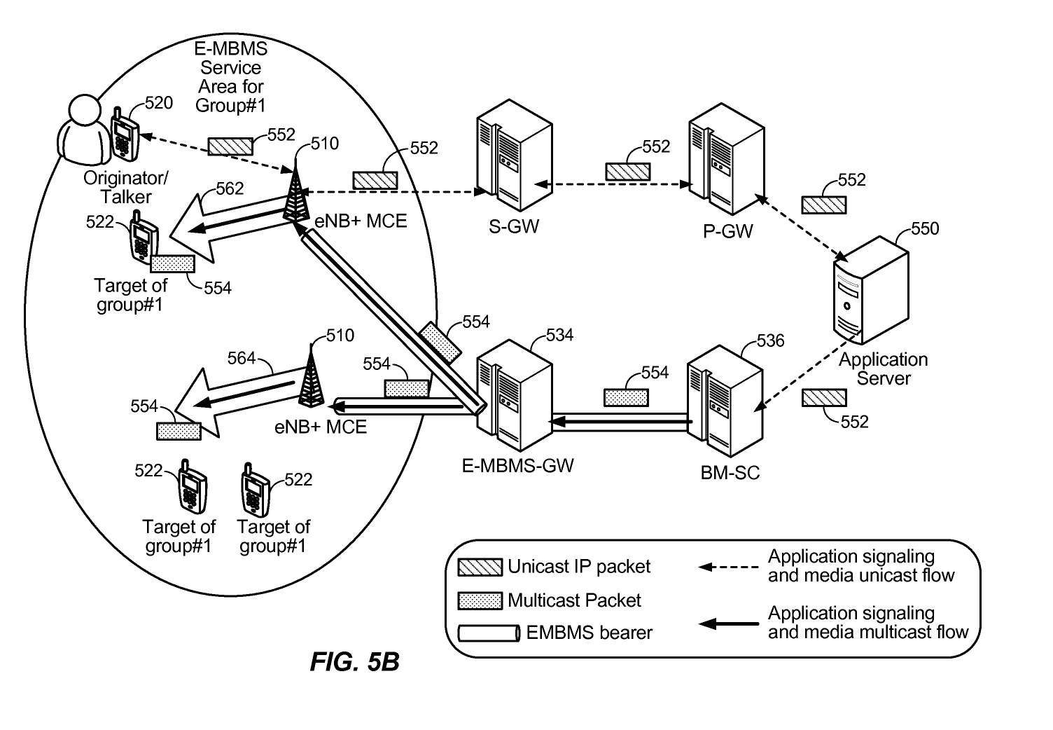

FIG. 5A is another illustration of a wireless network that can implement eMBMS or MBMS services, which are used interchangeably herein. An MBMS service area 500 can include multiple MBSFN areas (e.g. MBSFN area 1, 501 and MBSFN area 2, 502). Each MBSFN area can be supported by one or more eNode Bs 510, which are coupled to a core network 530. Core network 530 can include various elements (e.g., MME 532, eMBMS gateway 534, and broadcast multicast service center (BM-SC) 536 to facilitate controlling and distributing the content from content server 570 (which may include an application server, etc.) to the MBMS service area 500. The core network 530 may require a list of eNode Bs within the network, list of other downstream E-MBMS-GWs 534, and Mobility Management Entities (MMEs)/MCEs 532, and a mapping of the multicast IP address to the session identifier. UE 520 within the network can be provisioned with session identifiers and the multicast IP address of the content sent to it. Typically an MME is a key control node for the LTE access network. It is responsible for idle mode UE tracking and paging procedure including retransmissions. It is involved in the bearer activation/deactivation process and is also responsible for choosing the SGW for a UE at the initial attach and at time of intra-LTE handover involving core network 530 node relocation. The MME is also responsible for authenticating the user. The MME 532 can also check the authorization of the UE to camp on the service provider's Public Land Mobile Network (PLMN) and enforces UE roaming restrictions. The MME 532 is the termination point in the network for ciphering/integrity protection for Non Access Stratum (NAS) signaling and handles the security key management. The MME also provides the control plane function for mobility between LTE and 2G/3G access networks with S3 interface terminating at the MME.

FIG. 5B is another illustration of a wireless network that can implement MBMS as disclosed herein. In the illustrated network an application server 550 (e.g., PTT server) can serve as the content server. The application server 550 can communicate media in unicast packets 552 to the network core where the content can be maintained in a unicast configuration and transmitted as unicast packets to a given UE (e.g., originator/talker 520) or can be converted through the BM-SC to multicast packets 554, which can then be transported target UE's 522. For example, a PTT call can be initiated by UE 520 by communicating with application server 550 via unicast packets 552 over a unicast channel. It will be noted that for the call originator/call talker both the application signaling and media are communicated via the unicast channel on the uplink or the reverse link. The application server 550 can then generate a call announce/call setup request and communicate these to the target UEs 522. The communication can be communicated to the target UEs 522 via multicast packets 554 over a multicast flow, as illustrated in this particular example. Further, it will be appreciated in this example, that both the application signaling and media can be communicated over the multicast flow in the downlink or the forward link. Unlike conventional systems, having both the application signaling and the media in the multicast flow, avoids the need of having a separate unicast channel for the application signaling. However, to allow for application signaling over the multicast flow of the illustrated system, an evolved packet system (EPS) bearer will be established (and persistently on) between the BM-SC 536, EMBS GW 534, eNBs 510 and target UEs 522.

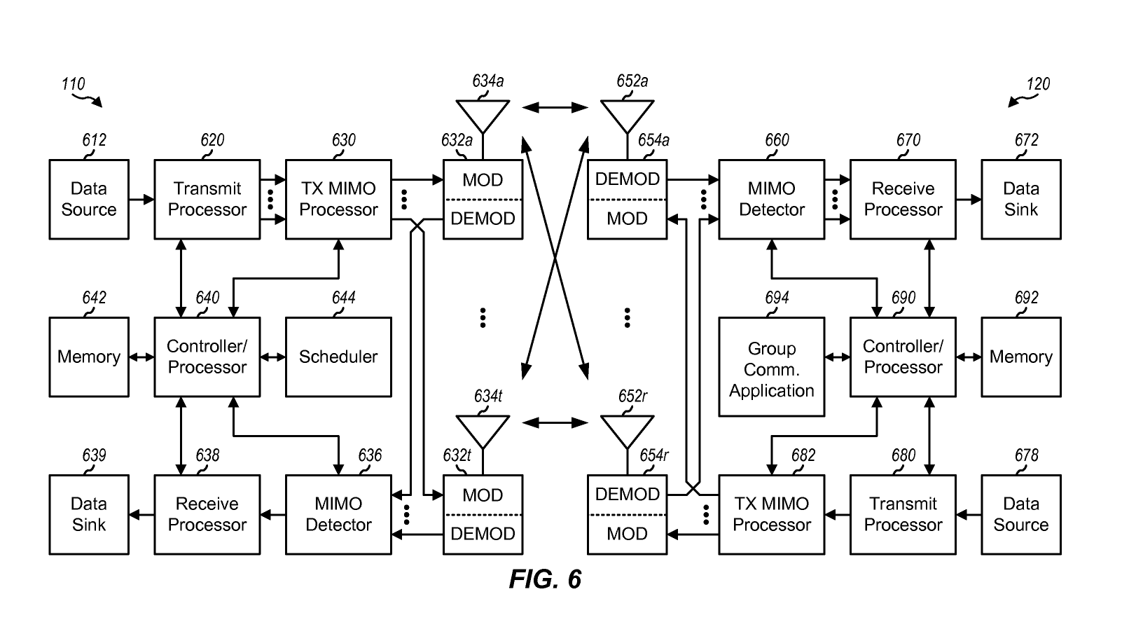

In accordance with various embodiments disclosed herein some of the downlink channels related to eMBMS will be further discussed, which include:
MCCH: Multicast Control Channel;
MTCH: Multicast Traffic Channel;
MCH: Multicast Channel; and
PMCH: Physical Multicast Channel.
   It will be appreciated that multiplexing of eMBMS and unicast flows are realized in the time domain only. The MCH is transmitted over MBSFN in specific sub frames on physical layer. MCH is a downlink only channel. A single transport block is used per sub frame. Different services (MTCHs) can be multiplexed in this transport block, as will be illustrated in relation to FIG. 6.

To achieve low latency and reduce control signaling, one eMBMS flow (562, 564) can be activated for each service area. Depending on the data rate, multiple multicast flows can be multiplexed on a single slot. PTT UEs (targets) can ignore and “sleep” between scheduled sub frames and reduce power consumption when no unicast data is scheduled for the UE. The MBSFN sub frame can be shared by groups in the same MBSFN service area. MAC layer signaling can be leveraged to “wake-up” the application layer (e.g., PTT application) for the target UEs.

Embodiments can use two broadcast streams, each a separate eMBMS flow over an LTE broadcast flow, with its own application level broadcast stream and its own (multicast IP address) for each defined broadcast region 502, 501 (e.g., a subset of sectors within the network). Although illustrated as separate regions, it will be appreciated that the broadcast areas 502, 501 may overlap.

In LTE, the control and data traffic for multicast is delivered over MCCH and MTCH, respectively. The Medium Access Control Protocol Data Units (MAC PDUs) for the UEs indicate the mapping of the MTCH and the location of a particular MTCH within a sub frame. An MCH Scheduling Information (MSI) MAC control element is included in the first subframe allocated to the MCH within the MCH scheduling period to indicate the position of each MTCH and unused subframes on the MCH. For eMBMS user data, which is carried by the MTCH logical channel, MCH scheduling information (MSI) periodically provides at lower layers (e.g., MAC layer information) the information on decoding the MTCH. The MSI scheduling can be configured and according to this embodiment is scheduled prior to MTCH sub-frame interval.

FIG. 6 illustrates a block diagram of a design of an eNode B 110 and UE 120, which may be one of the eNode Bs and one of the UEs discussed herein in relation to the various embodiments. In this design, Node B 110 is equipped with T antennas 634a through 634t, and UE 120 is equipped with R antennas 652a through 652r, where in general T is greater than or equal to 1 and R is greater than or equal to 1.

At Node B 110, a transmit processor 620 may receive data for unicast services and data for broadcast and/or multicast services from a data source 612 (e.g., directly or indirectly from application server 150). Transmit processor 620 may process the data for each service to obtain data symbols. Transmit processor 620 may also receive scheduling information, configuration information, control information, system information and/or other overhead information from a controller/processor 640 and/or a scheduler 644. Transmit processor 620 may process the received overhead information and provide overhead symbols. A transmit (TX) multiple-input multiple-output (MIMO) processor 630 may multiplex the data and overhead symbols with pilot symbols, process (e.g., precode) the multiplexed symbols, and provide T output symbol streams to T modulators (MOD) 632a through 632t. Each modulator 632 may process a respective output symbol stream (e.g., for OFDM) to obtain an output sample stream. Each modulator 632 may further process (e.g., convert to analog, amplify, filter, and upconvert) the output sample stream to obtain a downlink signal. T downlink signals from modulators 632a through 632t may be transmitted via T antennas 634a through 634t, respectively.

At UE 120, antennas 652a through 652r may receive the downlink signals from Node B 110 and provide received signals to demodulators (DEMOD) 654a through 654r, respectively. Each demodulator 654 may condition (e.g., filter, amplify, downconvert, and digitize) a respective received signal to obtain received samples and may further process the received samples (e.g., for OFDM) to obtain received symbols. A MIMO detector 660 may receive and process the received symbols from all R demodulators 654a through 654r and provide detected symbols. A receive processor 670 may process the detected symbols, provide decoded data for UE 120 and/or desired services to a data sink 672, and provide decoded overhead information to a controller/processor 690. In general, the processing by MIMO detector 660 and receive processor 670 is complementary to the processing by TX MIMO processor 630 and transmit processor 620 at Node B 110.

On the uplink, at UE 120, data from a data source 678 and overhead information from a controller/processor 690 may be processed by a transmit processor 680, further processed by a TX MIMO processor 682 (if applicable), conditioned by modulators 654a through 654r, and transmitted via antennas 652a through 652r. At Node B 110, the uplink signals from UE 120 may be received by antennas 634, conditioned by demodulators 632, detected by a MIMO detector 636, and processed by a receive processor 638 to obtain the data and overhead information transmitted by UE 120.

Controllers/processors 640 and 690 may direct the operation at Node B 110 and UE 120, respectively. Scheduler 644 may schedule UEs for downlink and/or uplink transmission, schedule transmission of broadcast and multicast services, and provide assignments of radio resources for the scheduled UEs and services. Controller/processor 640 and/or scheduler 644 may generate scheduling information and/or other overhead information for the broadcast and multicast services.

Controller/processor 690 may implement processes for the techniques described herein. Memories 642 and 692 may store data and program codes for Node B 110 and UE 120, respectively. Accordingly, group communications in the eMBMS environment can be accomplished in accordance with the various embodiments disclosed herein, while still remaining compliant with the existing standards.

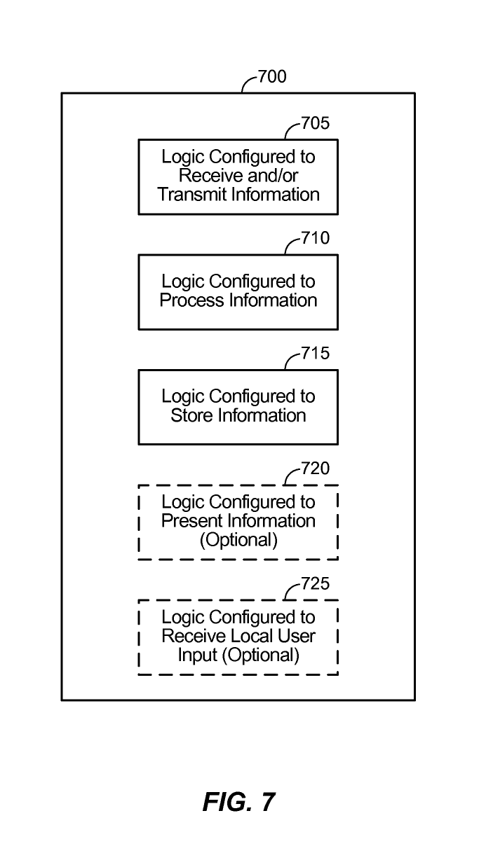

FIG. 7 illustrates a communication device 700 that includes logic configured to perform functionality. The communication device 700 can correspond to any of the above-noted communication devices, including but not limited to Node Bs 110 or 510, UEs 120 or 520, the application server 150, the network controller 130, the BM-SC 536, the content server 570, MME 532, E-MBMS-GW 532, etc. Thus, communication device 700 can correspond to any electronic device that is configured to communicate with (or facilitate communication with) one or more other entities over a network.

Referring to FIG. 7, the communication device 700 includes logic configured to receive and/or transmit information 705. In an example, if the communication device 700 corresponds to a wireless communications device (e.g., UE 120, Node B 110, etc.), the logic configured to receive and/or transmit information 705 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 705 can correspond to a wired communications interface (e.g., a serial connection, a USB or Firewire connection, an Ethernet connection through which the Internet 175 can be accessed, etc.). Thus, if the communication device 700 corresponds to some type of network-based server (e.g., the application server 150, the network controller 130, the BM-SC 536, the content server 570, MME 532, E-MBMS-GW 532, etc.), the logic configured to receive and/or transmit information 705 can correspond to an Ethernet card, in an example, that connects the network-based server to other communication entities via an Ethernet protocol. In a further example, the logic configured to receive and/or transmit information 705 can include sensory or measurement hardware by which the communication device 700 can monitor its local environment (e.g., an accelerometer, a temperature sensor, a light sensor, an antenna for monitoring local RF signals, etc.). The logic configured to receive and/or transmit information 705 can also include software that, when executed, permits the associated hardware of the logic configured to receive and/or transmit information 705 to perform its reception and/or transmission function(s). However, the logic configured to receive and/or transmit information 705 does not correspond to software alone, and the logic configured to receive and/or transmit information 705 relies at least in part upon hardware to achieve its functionality.

Referring to FIG. 7, the communication device 700 further includes logic configured to process information 710. In an example, the logic configured to process information 710 can include at least a processor. Example implementations of the type of processing that can be performed by the logic configured to process information 710 includes but is not limited to performing determinations, establishing connections, making selections between different information options, performing evaluations related to data, interacting with sensors coupled to the communication device 700 to perform measurement operations, converting information from one format to another (e.g., between different protocols such as .wmv to .avi, etc.), and so on. For example, the processor included in the logic configured to process information 710 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 710 can also include software that, when executed, permits the associated hardware of the logic configured to process information 710 to perform its processing function(s). However, the logic configured to process information 710 does not correspond to software alone, and the logic configured to process information 710 relies at least in part upon hardware to achieve its functionality.

Referring to FIG. 7, the communication device 700 further includes logic configured to store information 715. In an example, the logic configured to store information 715 can include at least a non-transitory memory and associated hardware (e.g., a memory controller, etc.). For example, the non-transitory memory included in the logic configured to store information 715 can correspond to random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. The logic configured to store information 715 can also include software that, when executed, permits the associated hardware of the logic configured to store information 715 to perform its storage function(s). However, the logic configured to store information 715 does not correspond to software alone, and the logic configured to store information 715 relies at least in part upon hardware to achieve its functionality.

Referring to FIG. 7, the communication device 700 further optionally includes logic configured to present information 720. In an example, the logic configured to display information 720 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 700. For example, if the communication device 700 corresponds to UE 120 or 520, the logic configured to present information 720 can include a display screen and an audio output device (e.g., speakers). In a further example, the logic configured to present information 720 can be omitted for certain communication devices, such as network communication devices that do not have a local user (e.g., network switches or routers, remote servers, etc.). The logic configured to present information 720 can also include software that, when executed, permits the associated hardware of the logic configured to present information 720 to perform its presentation function(s). However, the logic configured to present information 720 does not correspond to software alone, and the logic configured to present information 720 relies at least in part upon hardware to achieve its functionality.

Referring to FIG. 7, the communication device 700 further optionally includes logic configured to receive local user input 725. In an example, the logic configured to receive local user input 725 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 700. For example, if the communication device 700 corresponds to UE 120 or 520, the logic configured to receive local user input 725 can include a display screen (if implemented a touch-screen), a keypad, etc. In a further example, the logic configured to receive local user input 725 can be omitted for certain communication devices, such as network communication devices that do not have a local user (e.g., network switches or routers, remote servers, etc.). The logic configured to receive local user input 725 can also include software that, when executed, permits the associated hardware of the logic configured to receive local user input 725 to perform its input reception function(s). However, the logic configured to receive local user input 725 does not correspond to software alone, and the logic configured to receive local user input 725 relies at least in part upon hardware to achieve its functionality.

Referring to FIG. 7, while the configured logics of 705 through 725 are shown as separate or distinct blocks in FIG. 7, it will be appreciated that the hardware and/or software by which the respective configured logic performs its functionality can overlap in part. For example, any software used to facilitate the functionality of the configured logics of 705 through 725 can be stored in the non-transitory memory associated with the logic configured to store information 715, such that the configured logics of 705 through 725 each performs their functionality (i.e., in this case, software execution) based in part upon the operation of software stored by the logic configured to store information 705. Likewise, hardware that is directly associated with one of the configured logics can be borrowed or used by other configured logics from time to time. For example, the processor of the logic configured to process information 710 can format data into an appropriate format before being transmitted by the logic configured to receive and/or transmit information 705, such that the logic configured to receive and/or transmit information 705 performs its functionality (i.e., in this case, transmission of data) based in part upon the operation of hardware (i.e., the processor) associated with the logic configured to process information 710. Further, the configured logics or “logic configured to” of 705 through 725 are not limited to specific logic gates or elements, but generally refer to the ability to perform the functionality describe herein (either via hardware or a combination of hardware and software). Thus, the configured logics or “logic configured to” of 705 through 725 are not necessarily implemented as logic gates or logic elements despite sharing the word “logic.” Other interactions or cooperation between the configured logics 705 through 725 will become clear to one of ordinary skill in the art from a review of the embodiments described below in more detail.

According to the current eMBMS standards, the bearers for multicast calls are set up statically or semi-statically. That is, the bearers need to be established before the call is started. This means that the target geographical area has to be identified and the network components have to be connected with the resources allocated for the bearers. Additionally, the group member list needs to be pre-provisioned, resulting in a static group experience. Further, the eMBMS bearers must be maintained, which wastes over the air (OTA) and network resources.

The various embodiments improve OTA and backend resources for eMBMS by establishing a group communication (e.g., a PTT group call) by autonomously selecting the network components for setting up the eMBMS bearer(s) within a system supporting only static bearer setup for an ad hoc footprint using a combination of application layer and network layer mechanisms. In this way, the various embodiments can improve OTA resource usage and can provide on-demand group call setup for eMBMS without support of dynamic bearer establishment from the network.

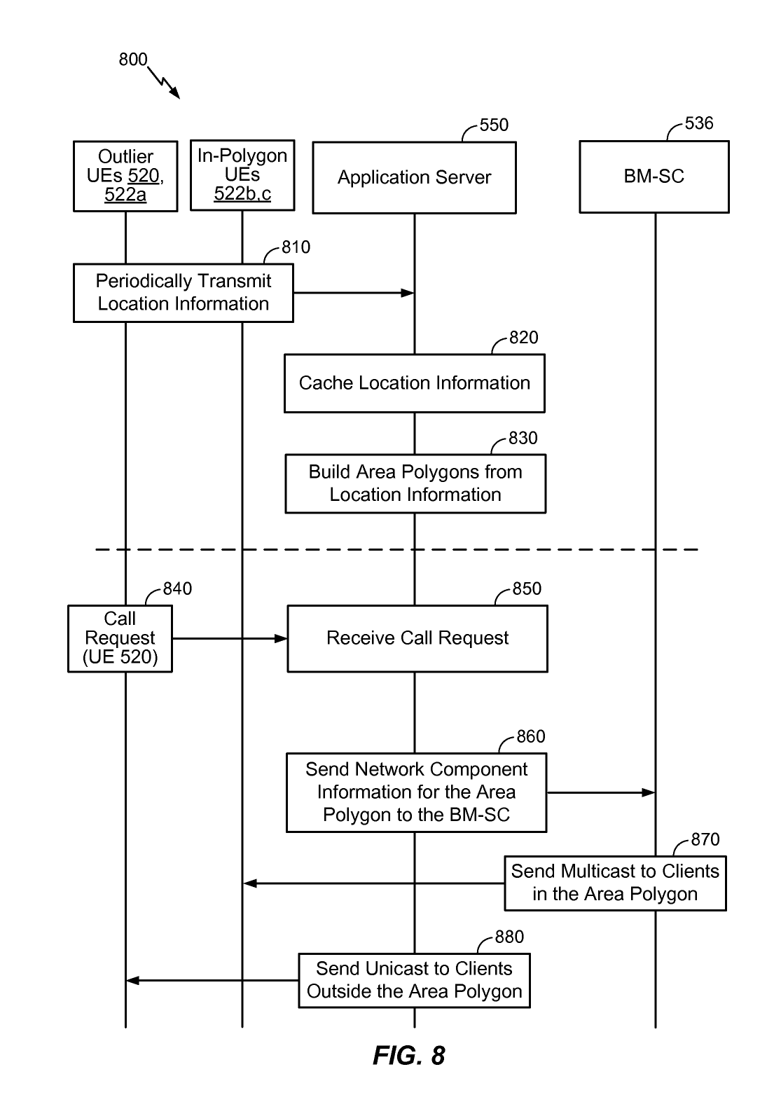

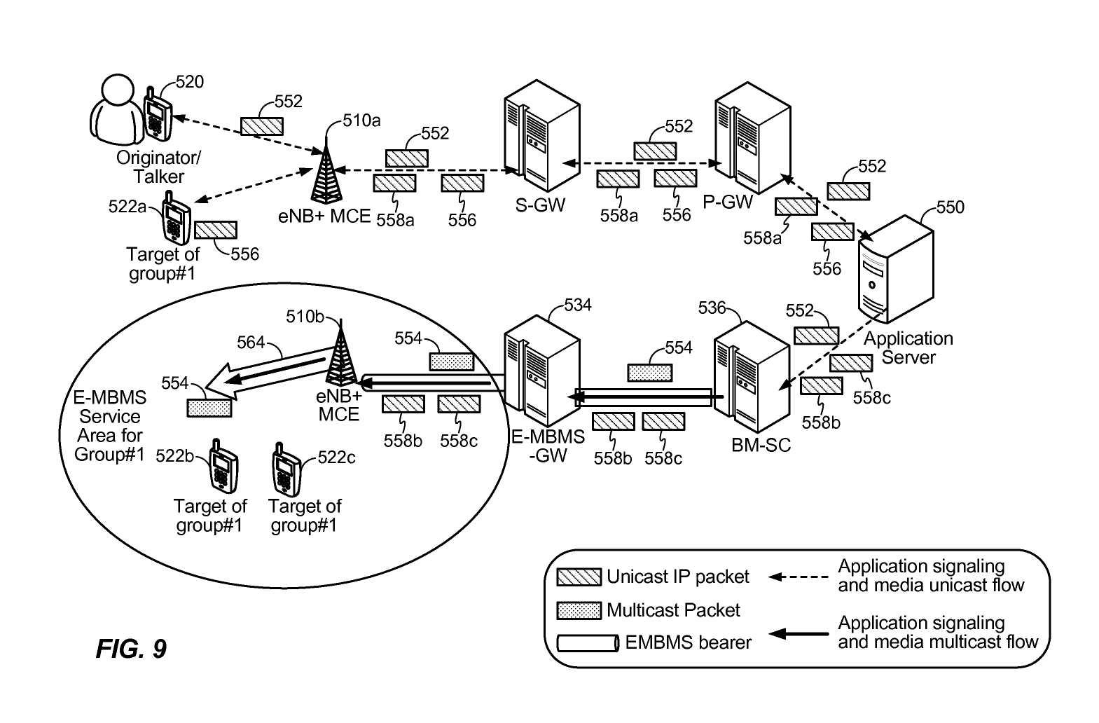

The various embodiments can accomplish this by implementing a client-assisted target multicast area detection, as described with reference to FIGS. 8-11. FIG. 8 illustrates a method 800 of detecting the target multicast area with client assistance according to an embodiment. FIG. 9 illustrates a system on which aspects of the embodiment of FIG. 8 can be implemented. It will be appreciated that FIG. 9 has many common components as illustrated in relation to the system of FIG. 5B. Thus, the description of the various shared components of FIG. 5B applies to FIG. 9, except as modified by the description of FIGS. 8 and 9 provided below.

Referring to FIG. 8, at 810, UEs capable of multicast service and interested in participating in multicast group communication periodically transmit their location and/or eNB information (referred herein generally as “location information”) to the application server 550. In the example of FIG. 8, UEs 520 and 522a-c are capable of multicast service and belong to the same multicast communication group. In the Figures, UEs 520 and 522a-c belong to multicast group #1. At 820, the application server 550 caches the location information received from the UEs 520 and 522a-c.

At 830, using the location information, the application server 550 builds area polygons for each UE of every group that is enabled for multicast transmission. An area polygon corresponds to the geographic area containing collocated UEs in the same multicast group. An area polygon can be defined as the set of cells or eNBs to which the user plane data for an eMBMS session should be directed. An area polygon definition can be represented by a unique area polygon value, code, or identifier. Area polygon information can include the identities of the network components, such as region(s), BM-SC(s), eMBMS-GW(s), MME(s), and eNB(s), for the UEs within the multicast group.

Generally, each multicast group is associated with one area polygon, and the area polygon need not cover a contiguous geographic area. Because the area polygon corresponds to a table or list of network components for providing an eMBMS session to a multicast group, the area polygon can be any shape and include any number of disparate geographic areas. Alternatively, an area polygon could be associated with a contiguous geographic area, and thus one multicast group could be associated with multiple area polygons where the multicast group members are located in disparate geographic areas.

When building an area polygon, there must be at least a threshold number of members of a multicast group sharing the same network components for the application server 550 to include those network components in the area polygon. If there is less than the threshold, or if any members are outside of a multicast service area, those members are omitted from the area polygon and will receive any group communications over unicast resources. A UE omitted from an area polygon is called an outlier.

In the example of FIGS. 8 and 9, UEs 520 and 522a-c belong to the same multicast group, i.e. group #1. UEs 522b and 522c are located within the same eMBMS service area, while UEs 520 and 522a are outliers. Accordingly, the application server 550 builds an area polygon that includes the network components associated with UEs 522b and 522c, and omits UEs 520 and 522a from the area polygon.

At 840, an originator UE, such as UE 520, transmits a call request for a group call to the application server 550. At 850, the application server 550 receives the call request (e.g., via a unicast packet) from UE 520, as was described above with reference to FIG. 5B.

At 860, the application server 550 begins the call setup by sending the network component information (e.g., eMBMS-GW, MME, MCE, eNB information) for the group call to the BM-SC 536 to establish the bearers for the multicast group. The application server 550 identifies the network components from the area polygon information for the multicast group, here comprising UEs 520 and 522a-c. Current eMBMS specifications support bearer establishment based on a network management operations by statically provisioning the downstream components where the bearers are to be established.

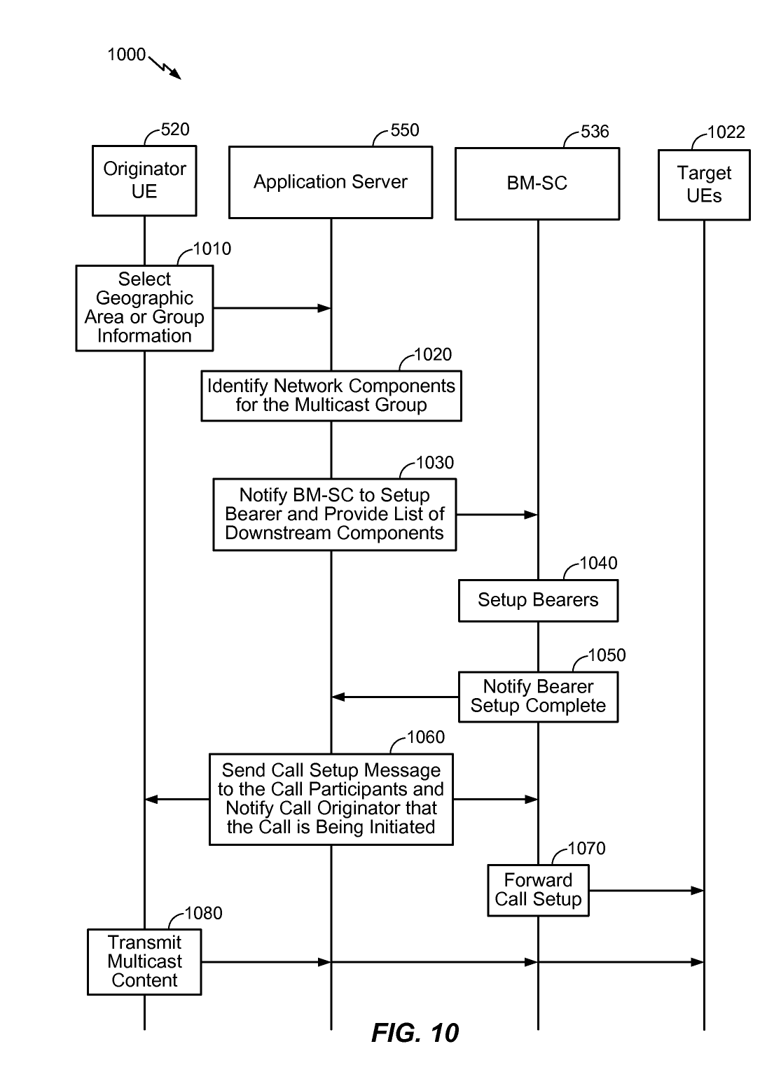

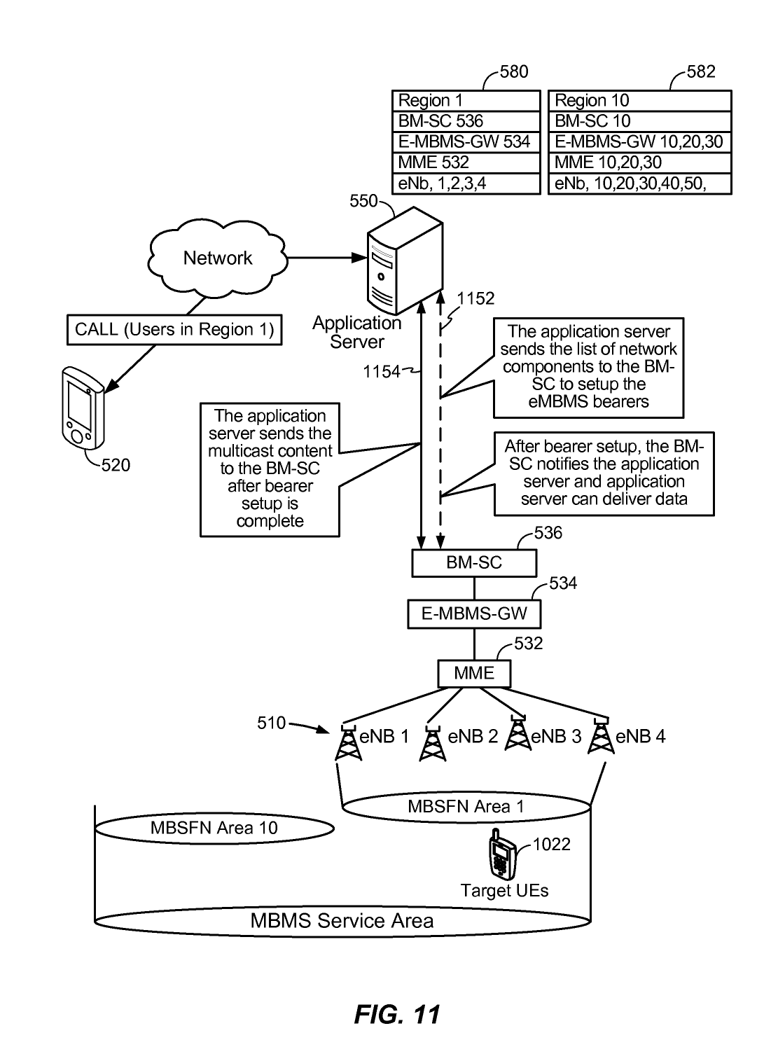

At 870, after the bearers are established, the BM-SC 536 sends multicast packet 554 to target UEs 522b and 522c, as discussed above with reference to FIG. 5B. As will be appreciated, there may be any number of target UEs within the area polygon of multicast group 1, not just target UEs 522b and 522c. In that case, BM-SC 536 would send multicast packet 554 to all of them. Additional details regarding the multicast call will be discussed in relation to FIG. 10 and FIG. 11.

At 880, the application server 550 sends a unicast packet 556 to target UE 522a, as it was identified as an outlier (e.g., not part of any multicast area). It will be appreciated that there may be more than one outlier UE in multicast group #1. In that case, application server 550 can send media to all such outliers over unicast. Further, it will be appreciated that the transmission of the group media is conducted essentially simultaneous, even though discussed sequentially in relation to blocks 860-880.

Referring to FIG. 9, the originator UE 520 and target UEs 522a-c transmit location information to the application server 550 in the form of unicast packets 558a-c. Target UEs 522a-c are capable of multicast service and are interested in participating in a multicast group communication. It will be appreciated that UEs 520 and 522a-c can transmit their location information periodically or upon the occurrence of some event. The location information may be the location of the target UEs 522a-c and/or the eNB information of the eNB 510 servicing the UEs 520 and 522a-c.

As discussed above, the application server 550 determines area information corresponding to the UEs 520 and 522a-c by building an area polygon from the location information of each UE 520 and 522a-c. The area polygon corresponds to the network components for geographically collocated UEs. The UEs may belong to different multicast groups, in which case, the area polygons are built based on the locations of the members of the group, rather than the locations of all UEs in the system. Any outlier UEs are omitted from the multicast area polygons.

For example, in FIG. 9, UEs 520 and 522a-c all belong to multicast group #1. UEs 522b and 522c are collocated in the service area of eNB 510b, which is in an eMBMS service area for group #1. Accordingly, UEs 522b and 522c may be part of one area polygon within the eMBMS service area for group #1. In contrast, UEs 520 and 522a are collocated in the service area of eNB 510a, which is not in the eMBMS service area for group #1. As such, UEs 520 and 522a are outliers located outside the eMBMS service area for group #1.

It will be apparent to one of ordinary skill in the art that FIG. 9 is an example only, and that any number of UEs may belong to multicast group #1, and any number of those UEs may be serviced by eNB 510, or any other eNB. The other UEs of multicast group #1 may belong to the same area polygon as UEs 522b and 522c or one or more other area polygons. Additionally, there may also be other multicast groups with overlapping or adjacent service areas and one UE may be a member of multiple groups. However, for purposes of establishing a given group call, the specific group of interest is what is used to determine if the UE is within a defined multicast service area or an outlier, as determined at by the application server 550.

In the example of FIG. 9, the application server 550 sends the network component information to the BM-SC 536 for the area polygon(s) including target UEs 522b and 522c that form the eMBMS multicast service area. Target UE 522a does not belong the eMBMS multicast service area, so the application server 550 does not send the BM-SC 536 any information about its corresponding network components. Since the application server 550 already knows the area information (from the calculated area polygons) for the target UEs 522, call setup is much faster than if the application server 550 had to determine location information of each UE 522 when the call request is received from originator UE 520. That is, when the application server 550 receives a multicast call, it simply looks up the area polygon(s) for the identified multicast group or identified target UEs, here UEs 522a-c, and sends the corresponding network component information to the BM-SC 536 to set up the bearers for the multicast group. Additionally, it will be appreciated that since the bearer setup is dynamic, the various embodiments can conserve system resources since the bearers do not have to be pre-established.

FIG. 10 illustrates a method 1000 of conducting a multicast call according to an embodiment with deferred call setup until the eMBMS bearers are established. At 1010, a call originator, such as UE 520, can select a geographic area (e.g. by latitude and longitude, city name, etc.) that includes multicast-capable UEs, such as target UEs 1022. Alternatively, the originator UE 520 can provide the application server 550 with the group information and the application server 550 will detect the target geographic area(s). For example, the call originator 520 may wish to broadcast a call to all target UEs in New York City, or may wish to broadcast a call to members of a particular multicast group and request for a deferred call setup after the eMBMS bearers are established.

At 1020, the application server 550 identifies the network components needed for the multicast group call based on the call request message received from the originator 520 (e.g., city, group, etc.). If the call is to a specific multicast group, the application server 550 can look up the area polygon(s) associated with that group, which identify the network components serving the group members. If the call is to a particular location, the application server can look up the downstream network components providing multicast services for that location. The application server 550 can look up the network components for both types of calls using the same list or table, or using separate lists or tables. That is, a single list or table can include all downstream network components in the system, with corresponding fields for location, area polygon, group, etc. Alternatively, the application server 550 may have a list or table of multicast groups with their corresponding area polygon(s) and a separate list or table of locations with their corresponding network components. There are any number of ways to organize the listing of network components, area polygons, locations, groups, etc., and this disclosure is not limited to the examples provided here.

At 1030, the application server 550 notifies the BM-SC 536 to setup the eMBMS bearer(s) and supplies the list of downstream network components identified in 1020. At 1040, the BM-SC 536 sets up the identified bearers. At 1050, the BM-SC 536 notifies the application server 550 that bearer setup is complete. At this point the application server 550 resumes the deferred call setup. The application server 550 determines that the bearers for the call are setup and the request for a group call on the eMBMS interface can be executed as a result of the available bearers.

At 1060, the application server 550 responds to the BM-SC 536 by sending further call setup messages to the target UEs 1022 and notifying the call originator 520 that the call is being initiated. At 1070, the BM-SC 536 forwards the call setup messages to the multicast group of target UEs 1022.

At 1080, in response to the notification from the application server 550, the originator UE 520 begins transmitting the content for the multicast call. The call is arbitrated through the application server 550, and the BM-SC 536 forwards the multicast content on the newly established bearers on pre-allocated Temporary Mobile Group Identities (TMGIs) for of the group call. The target UEs 1022 are pre-provisioned with a pool of TMGIs for various calls including the group call and are thus able to participate in the group call.

FIG. 11 illustrates a system level diagram of components that can be used to implement the various embodiments of FIG. 10. For example, an originator UE 520 can communicate with the application server 550 over a wireless network. In alternative embodiments, however, the originator UE 520 can also communicate with the application server 550 via a wired (e.g. an Ethernet connect to the Internet) network or a network having a combination of wired and wireless links.

As discussed above, after the application server 550 receives the call request, which includes a targeted group, geographic area, etc., from the originator UE 520, the application server 550 can provide a list of downstream network components to the appropriate BM-SC based on the stored list or table of network components. In the example of FIG. 11, the application server 550 sends list 580 to the BM-SC 536 because the originator UE 520 has identified region 1, corresponding to MBSFN area 1, as the geographic area in which the call should be multicast. Alternatively, the originator UE 520 could specify the multicast group, in which case the application server 550 would send list 580 to BM-SC 536 if the area polygon associated with the multicast group corresponds to region 1.

In the example of FIG. 11, target UEs 1022 are all the multicast-capable UEs in region 1. Alternatively, target UEs 1022 could be the members of the multicast group identified in a call request located in region 1.

In FIG. 11, the application server 550 also has access to list 582 for MBSFN area 10. However, none of the target UEs 1022 are in MBSFN area 10, so the application server does not send list 582 to the identified BM-SC.

The application server 550 can communicate the list 580 over the application server 550/BM-SC 536 signaling interface 1152. Once the bearers are established, as discussed above, the multicast content can be communicated over the application server 550/BM-SC 536 data interface 1154. The BM-SC 536 provides the multicast content to the target UEs 1022 via the various downstream network components (e.g., eMBMS-GW 534, MME 532, and eNBs 1, 2, 3, and 4 510).

Although example methods identifying area information of target UEs has been described above, the various embodiments of the invention are not limited to these example embodiments. For example, an area polygon (which may also be considered a “geo-fence,” because it sets the boundaries of a geographical area) can be identified by requesting the location from a selective group of target UEs. These UEs can be chosen based on a prediction algorithm calculated at the application server 550 that concludes that these UEs may form the geo-fence based on their current known locations in the system. Once the geographic boundary is identified, and using the mapping of the network nodes to the geographic boundary available at the application server 550, this information can be provided to the BM-SC 536 to set up the bearer(s) as needed.

In an alternate embodiment, if the number of target UEs reporting information for the multicast call is below a threshold, the call may hosted on a unicast service. Still further, multicast-capable UEs and the application server 550 may be pre-provisioned with an index for geographic locations, e.g. a city, area of interest (e.g., amusement park, sports stadium), etc.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for group communications over eMBMS. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for group communications over multimedia broadcast/multicast services (MBMS), comprising:
receiving location information for each of a plurality of multicast-enabled target user devices;
determining one or more area polygons based on the location information, each area polygon comprising a list of network components configured to provide multicast services to a subset of the plurality of multicast-enabled target user devices; and
storing the one or more area polygons.

2. The method of claim 1, wherein the location information comprises geographic positioning system (GPS) coordinates and/or node B information of each of the plurality of the multicast-enabled target user devices.

3. The method of claim 1, wherein the network components comprise one or more of a broadcast multicast service center (BM-SC), an MBMS gateway (MBMS-GW), a mobility management entity (MME), or a node B.

4. The method of claim 1, wherein a subset of the plurality of multicast-enabled target user devices associated with an area polygon are collocated in a geographic area.

5. The method of claim 4, wherein the area polygon corresponds to the geographic area.

6. The method of claim 1, wherein the method is performed at an application server.

7. The method of claim 6, wherein each of the plurality of multicast-enabled target user devices transmits the location information to the application server.

8. A method for group communications over multimedia broadcast/multicast services (MBMS), comprising:
receiving a call request to establish a group call among a plurality of multicast-enabled target user devices;
identifying one or more area polygons corresponding to the plurality of multicast-enabled target user devices, wherein each of the one or more area polygons comprise a list of network components configured to provide multicast services to a subset of the plurality of multicast-enabled target user devices; and
providing a list of network components obtained from the one or more area polygons to one or more broadcast multicast service centers (BM-SCs) serving the plurality of multicast-enabled target user devices.

9. The method of claim 8, wherein the one or more BM-SCs setup one or more multicast bearers in the one or more area polygons before the group call is scheduled.

10. The method of claim 9, wherein the one or more multicast bearers comprise one or more MBMS bearers.

11. The method of claim 9, further comprising:
receiving notification from the one or more BM-SCs of successful setup of the one or more bearers; and
in response, notifying a call originator of the successful setup of the one or more bearers.

12. The method of claim 8, further comprising:
receiving an indication from the one or more BM-SCs that the one or more multicast bearers have been setup for the group call; and
hosting the group call for the plurality of multicast-enabled target user devices over the one or more multicast bearers.

13. The method of claim 8, wherein the call request identifies a geographic area in which to multicast the group call.

14. The method of claim 13, wherein the plurality of multicast-enabled target user devices are all of the multicast-enabled user devices within the geographic area.

15. The method of claim 13, wherein a single area polygon corresponds to the geographic area.

16. The method of claim 8, wherein the call request identifies a multicast communications group to which to multicast the group call.

17. The method of claim 16, wherein the multicast communications group comprises the plurality of multicast-enabled target user devices.

18. The method of claim 16, wherein more than one of the one or more area polygons correspond to the multicast communications group.

19. The method of claim 16, wherein a single area polygon corresponds to the multicast communications group.

20. An apparatus for group communications over multimedia broadcast/multicast services (MBMS), comprising:
logic configured to receive location information for each of a plurality of multicast-enabled target user devices;
logic configured to determine one or more area polygons based on the location information, each area polygon comprising a list of network components configured to provide multicast services to a subset of the plurality of multicast-enabled target user devices; and
logic configured to store the one or more area polygons.

21. The apparatus of claim 1, wherein the location information comprises geographic positioning system (GPS) coordinates and/or node B information of each of the plurality of the multicast-enabled target user devices.

22. The apparatus of claim 1, wherein the network components comprise one or more of a broadcast multicast service center (BM-SC), an MBMS gateway (MBMS-GW), a mobility management entity (MME), or a node B.

23. The apparatus of claim 1, wherein a subset of the plurality of multicast-enabled target user devices associated with an area polygon are collocated in a geographic area.

24. The apparatus of claim 23, wherein the area polygon corresponds to the geographic area.

25. The apparatus of claim 1, wherein the method is performed at an application server.

26. The apparatus of claim 25, wherein each of the plurality of multicast-enabled target user devices transmits the location information to the application server.

27. An apparatus for group communications over multimedia broadcast/multicast services (MBMS), comprising:
logic configured to receive a call request to establish a group call among a plurality of multicast-enabled target user devices;
logic configured to identify one or more area polygons corresponding to the plurality of multicast-enabled target user devices, wherein each of the one or more area polygons comprise a list of network components configured to provide multicast services to a subset of the plurality of multicast-enabled target user devices; and
logic configured to provide a list of network components obtained from the one or more area polygons to one or more broadcast multicast service centers (BM-SCs) serving the plurality of multicast-enabled target user devices.

28. The apparatus of claim 27, wherein the one or more BM-SCs setup one or more multicast bearers in the one or more area polygons before the group call is scheduled.

29. The apparatus of claim 28, wherein the one or more multicast bearers comprise one or more MBMS bearers.

30. The apparatus of claim 28, further comprising:
logic configured to receive notification from the one or more BM-SCs of successful setup of the one or more bearers; and
logic configured to notify, in response, a call originator of the successful setup of the one or more bearers.

31. The apparatus of claim 27, further comprising:
logic configured to receive an indication from the one or more BM-SCs that the one or more multicast bearers have been setup for the group call; and
logic configured to host the group call for the plurality of multicast-enabled target user devices over the one or more multicast bearers.

32. The apparatus of claim 27, wherein the call request identifies a geographic area in which to multicast the group call.

33. The apparatus of claim 32, wherein the plurality of multicast-enabled target user devices are all of the multicast-enabled user devices within the geographic area.

34. The apparatus of claim 32, wherein a single area polygon corresponds to the geographic area.

35. The apparatus of claim 27, wherein the call request identifies a multicast communications group to which to multicast the group call.

36. The apparatus of claim 35, wherein the multicast communications group comprises the plurality of multicast-enabled target user devices.

37. The apparatus of claim 35, wherein more than one of the one or more area polygons correspond to the multicast communications group.

38. The apparatus of claim 35, wherein a single area polygon corresponds to the multicast communications group.

39. An apparatus for group communications over multimedia broadcast/multicast services (MBMS), comprising:
means for receiving location information for each of a plurality of multicast-enabled target user devices;
means for determining one or more area polygons based on the location information, each area polygon comprising a list of network components configured to provide multicast services to a subset of the plurality of multicast-enabled target user devices; and
means for storing the one or more area polygons.

40. An apparatus for group communications over multimedia broadcast/multicast services (MBMS), comprising:
means for receiving a call request to establish a group call among a plurality of multicast-enabled target user devices;
means for identifying one or more area polygons corresponding to the plurality of multicast-enabled target user devices, wherein each of the one or more area polygons comprise a list of network components configured to provide multicast services to a subset of the plurality of multicast-enabled target user devices; and
means for providing a list of network components obtained from the one or more area polygons to one or more broadcast multicast service centers (BM-SCs) serving the plurality of multicast-enabled target user devices.

41. A non-transitory computer-readable medium for group communications over multimedia broadcast/multicast services (MBMS), comprising:
at least one instruction to receive location information for each of a plurality of multicast-enabled target user devices;
at least one instruction to determine one or more area polygons based on the location information, each area polygon comprising a list of network components configured to provide multicast services to a subset of the plurality of multicast-enabled target user devices; and
at least one instruction to store the one or more area polygons.

42. A non-transitory computer-readable medium for group communications over multimedia broadcast/multicast services (MBMS), comprising:
at least one instruction to receive a call request to establish a group call among a plurality of multicast-enabled target user devices;
at least one instruction to identify one or more area polygons corresponding to the plurality of multicast-enabled target user devices, wherein each of the one or more area polygons comprise a list of network components configured to provide multicast services to a subset of the plurality of multicast-enabled target user devices; and
at least one instruction to provide a list of network components obtained from the one or more area polygons to one or more broadcast multicast service centers (BM-SCs) serving the plurality of multicast-enabled target user devices.
